(19) United States
(12) Patent Application Publication
(10) Pub. No.: US 2010/0014973 A1
(43) Pub. Date: Jan. 21, 2010

(54) Vertical Axis Fluid Flow Turbine System

(76) Inventor: Carlos Manuel Perez Romo, Queretaro (MX)

Correspondence Address: RUBEN ALCOBA, ESQ., 3399 NW 72 AVENUE, SUITE211, MIAMI, FL, 33122, US

(21) Appl. No.: 12/176,352

(22) Filed: Jul. 19, 2008

(51) Int. Cl. F03D 7/06; F03D 3/02

(52) U.S. Cl. 416/33; 416/124; 416/244 R

(57) ABSTRACT

The present invention is vertical axis fluid flow turbine system for generating an alternative fuel. The turbines of the present invention are centered between at least two support structures so that the rotor holding the hub and the blades is perpendicular to the ground, rooftop, or the floor of a body of water and the axis of the blades coming from the hub are parallel to the ground, rooftop, floating structure, or the floor of a body of water. The turbines are secured to the support structures using struts. The struts are attached to each support structure and to the nacelle of each turbine. Attaching each turbine in this manner allows the turbines of the present invention to be stacked one on top of the other, that in turns minimizes the footprint of the vertical axis fluid flow turbine system.

### BACKGROUND

The present invention is directed to fluid flow turbine systems, more specifically to vertical axis fluid flow turbine systems. Vertical axis fluid flow turbine systems have their main rotor arranged vertically. The difference between vertical axis fluid flow turbines and the present invention is that the present invention's axis of the blades of the rotor is parallel to the ground (or support structure holding the turbine system) and run from the hub of the rotor to the tip of the blades. The blades are rotated to provide an optimum resistance to fluid flows.

Arranging the main rotor vertically has the advantage that the turbine does not need to be pointed toward the fluid flow to be effective. The reason that the turbine does not have to be pointed toward the fluid flow to be effective is because fluid flows, such as wind or water currents, will naturally change direction, however they will still remain parallel to the ground. So in all vertical-axis turbines, the flow remains perpendicular to the axis, regardless of the flow direction, and the turbines always rotate in the same direction. This is one of the main advantages of vertical-axis turbines. The present invention ideally will be placed on rooftops, the ground, or the floor of a body of water.

Georges Jean Marie Darrius patented the first vertical axis wind turbine (hereinafter referred as “VAWT”). His invention consisted of a number of areofoils vertically mounted on a rotating shaft. The aerofoils of the Darrius rotor move forward through the air in a circular path. The efficiency of this type of wind turbine theoretically is the same as propeller type wind turbines, yet the efficiency is rarely realized due to the practical design and the wind speed variation.

The inventor of the present invention realized that he had to invent a vertical axis fluid flow turbine (hereinafter referred as “VAFFT”) system that he could place on a roof of a building, the ground, or the floor of a body of water and that the system had to have the capacity to allow VAFFTs to be stacked in a vertical serial manner so that the footprint of the VAFFT system could maximize the amount of fluid flows that could pass through the system.

The following are VAWT related patents: Darrius, U.S. Pat. No. 1,835,018; Nemec, U.S. Pat. No. 6,320,273 B1; Kutcher, U.S. Pat. No. 4,449,053; Campbell, U.S. Pat. No. 4,364,710; Musgrove, U.S. Pat. No. 4,087,203; Zheng, U.S. Pat. No. 4,435,124; Kaiser, U.S. Pat. No. 4,130,380; Boile, U.S. Pat. No. 4,204,805; Seki et al., U.S. Pat. No. 4,247,253; Delgado et al., U.S. Pat. No. 4,274,809; Liljegren, U.S. Pat. No. 4,430,044; Watson et al., U.S. Pat. No. 4,525,124; Reiner, U.S. Pat. No. 4,979,871; and Verastequi, U.S. Pat. No. 5,518,367. All of the above patents are constructed to rest on a vertical tower. The turbines of the present invention are centered between at least two support structures so that the rotor holding the hub and the blades is perpendicular to the ground, rooftop, or the floor of a body of water:and the axis of the blades coming from the hub are parallel to the ground. The turbines are secured to the support structures using struts. The struts are attached to each support structure and to the nacelle of each turbine. Attaching each turbine in this manner allows the turbines of the present invention to be stacked one on top of the other, which in turn minimizes the footprint of the VAFFT system.

The inventor designed the present invention in the manner described above so that fluid flow turbines would be used in metropolitan areas, the ground, or the floor of a body of water. The reason he decided to stack the turbines is that he knew rooftops, the ground, or the floor of a body of water only have a certain amount of square footage to capture fluid flows. He realized that by stacking the fluid flow turbines he could maximize the amount of energy created per square foot used on a surface.

An object of the present invention is to capture the maximum amount of fluid flow within a certain area of a roof top, the ground, or the floor of a body of water to create energy.

A further object of the present invention is to securely place a fluid flow turbine on top of a building.

Yet another object of the present invention is to place a fluid flow turbine system within a metropolitan area.

Still another object of the present invention is to promote developers of metropolitan buildings to place alternative energy sources on metropolitan building rooftops.

Another object of the present invention is to place a fluid flow turbine system under a body of water.

For the foregoing reasons, there is a need for a VAFFT system that can be placed on roofs of buildings or other structures.

### SUMMARY

The present invention is directed to a vertical axis fluid flow turbine system that can be used in metropolitan areas, the ground, or the floor of a body of water. The vertical axis fluid turbines of the present invention are vertically stacked on rooftops, the ground, or the floor of a body of water so that fluid flows captured by the turbine system can be maximized within the footprint of the turbine system. In turn, the invention maximizes the amount of energy created per square foot used on a surface securing the present invention.

In one embodiment of the present invention, the vertical axis fluid flow turbine system comprises of the following elements. At least one vertical axis fluid flow turbine, the fluid flow turbine having a rotor, a break, a low speed shaft, a gear box, a high speed shaft, a generator, a controller, and a nacelle, the rotor comprises of a hub and at least two blades, the blades are propeller styled blades that extend outward from the hub so that the axis of the blades are perpendicular to low speed shaft, the nacelle houses all the elements of the fluid flow turbine except the rotor and the blades; at least two beams, each beam being of a diameter and structural strength to support the weight of at least one vertical axis fluid flow turbine or any combination of vertical axis fluid flow turbines made to be supported between the beams. A base, the beams being securely attached to the base so that the beams are perpendicular to the base, the beams being spaced apart so that the axis of each blade of each vertical axis fluid flow turbine will have enough clearance to spin within the beams. At least one set of struts, each set of struts has at least two rods, each rod being of an equal length and diameter and having the structural strength to hold the weight of one vertical axis fluid flow turbine, each rod is securely attached to each beam and the nacelle of each vertical axis fluid flow turbine is supported between the beams. And, a conductor connected to the generator.

The blades of the present invention are constructed of materials known in the art and are constructed so that one side of each blade is nearly flat or somewhat concave from the chord and the other side of each blade is convex. The blades of the present invention are constructed to maximize the use of Bernoulli's principle.

In another embodiment of the present invention, the vertical axis fluid flow turbine system has at two vertical axis fluid flow turbines supported by the beams, the fluid flow turbines are spaced apart so that the nacelle of one of the fluid flow turbines does not touch the rotor of the second fluid flow turbine and wherein nacelles of the fluid flow turbines are colinear.

In a further embodiment of the present invention, there is at least a third vertical axis fluid flow turbine that connects to the beams and is spaced apart so that the nacelle of the third fluid flow turbine and any subsequent turbine does not touch the rotor of any other fluid flow turbine being supported by the beams, and wherein the nacelles of all of the fluid flow turbines are colinear.

In yet another embodiment of the present invention, the controller controls the blades to rotate to a desired pitch thereby allowing the fluid flow turbine's blades to be adjusted to provide the optimum resistance to fluid flows.

In still another embodiment of the present invention, there are at least three beams equally spaced apart supporting the vertical axis fluid flow turbines.

In all of the embodiments referred above, the base could either be a roof top, the ground, or the floor of a body of water.

### DRAWINGS

These and other features, aspects, and advantages of the present invention will become better understood with regard to the following description, appended claims, and drawings where:

FIG. 1 shows a perspective view of a vertical axis fluid flow turbine system, wherein one fluid flow turbine is supported by the vertical axis fluid flow turbine system;

FIG. 2 shows a perspective view of a vertical axis fluid flow turbine system, wherein various fluid flow turbines are supported by the vertical axis fluid flow turbine system; and

FIG. 3 shows a fluid flow turbine “Prior Art.”

### DESCRIPTION

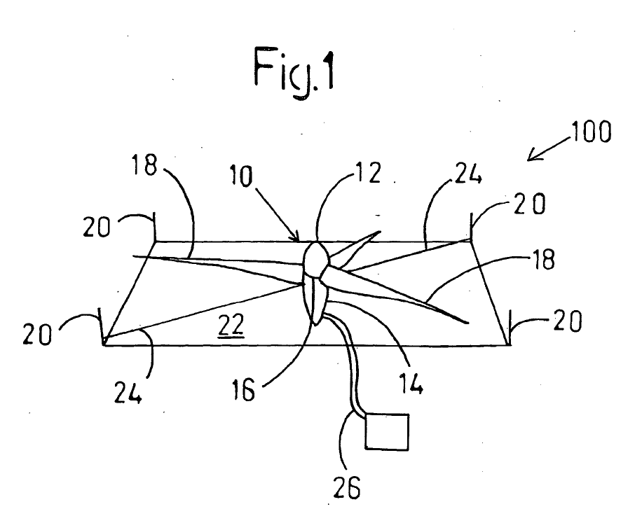

As seen in FIG. 1, a vertical axis fluid flow turbine system 100 comprises: at least one vertical axis fluid flow turbine 10, the fluid flow turbine has a rotor 12, a break (not seen in Figures), a low speed shaft (not seen in Figures), a gear box (not seen in Figures), a high speed shaft (not seen in Figures), a generator (not seen in Figures), a controller (not seen in figures), and a nacelle 14, the rotor comprises of a hub 16 and at least two blades 18, the blades 18 are propeller styled blades that extend outward from the hub 16 so that the axis of the blades 18 are perpendicular to low speed shaft (not shown in the Figures), the nacelle 14 houses all the elements of the fluid flow turbine 10 except the rotor 12 and the blades 18; at least two beams 20, each beam 20 being of a diameter and structural strength to support the weight of at least one vertical axis fluid flow turbine 10 or any combination of vertical axis fluid flow turbines 10 made to be supported between the beams 20; a base 22, the beams 20 being securely attached to the base 22 so that the beams 20 are perpendicular to the base 22, the beams 22 being spaced apart so that the axis of each blade 18 of each vertical axis fluid flow turbine 10 will have enough clearance to spin within the beams 20; at least one set of struts 24, each set of struts 24 has at least two rods 24, each rod 24 being of an equal length and diameter and having the structural strength to hold the weight of one vertical axis fluid flow turbine 10, each rod 24 is securely attached to each beam 20 and the nacelle 14 of each vertical axis fluid flow turbine 10 supported between the beams 20; and a conductor connected 26 to the generator (not seen in Figures, for the generator is housed within the nacelle 14).

The blades 18 of the fluid flow turbines 10 are shaped so that one side of each blade 18 is nearly flat or somewhat concave from the chord and the other side of each blade 18 is convex. The blades 18 of the present invention are constructed to maximize the use of Bernoulli's principle. The blades 18 of the present invention are constructed of materials known in the art.

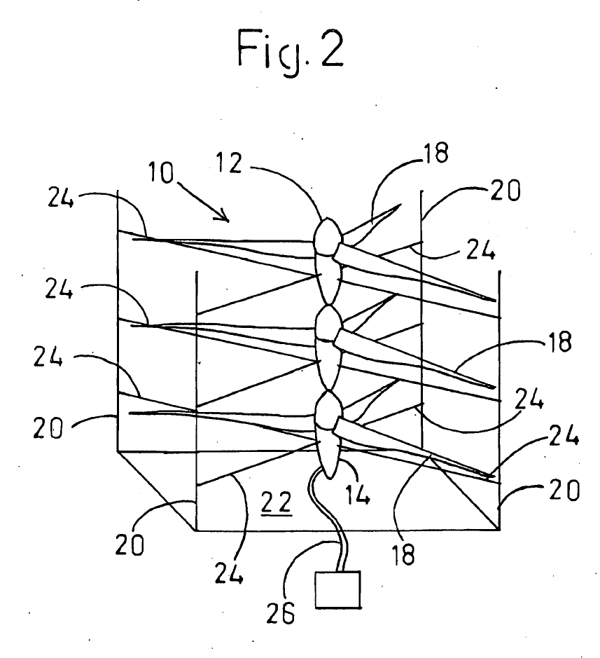

As seen in FIG. 2, in another embodiment of the present invention, two vertical axis fluid flow turbines 10 supported by the beams 20 of the vertical axis fluid flow turbine system 100, the fluid flow turbines 10 being spaced apart so that the nacelle 14 of one of the fluid flow turbines 10 does not touch the rotor 12 of the second fluid flow turbine 10 and wherein the nacelles 14 of the fluid flow turbines 10 are colinear.

As seen in FIG. 2, in a further embodiment of the present invention, there is at least a third vertical axis fluid flow turbine 10 connected to the beams 20 and third vertical axis fluid flow turbine 10 is spaced apart so that the nacelle 14 of the third fluid flow turbine 10 and any subsequent turbine 10 does not touch the rotor 12 of any other fluid flow turbine 10 being supported by the beams 20, and wherein the nacelles 14 of all of the fluid flow turbines 10 are colinear.

In another embodiment of the present invention, the controller (Not seen in Figures) of each vertical axis fuel turbine controls the blades 18 to rotate to a desired pitch thereby allowing the fluid flow turbine's blades 18 to be adjusted to provide the optimum resistance to fluid flows.

As seen in FIGS. 1-2, in a further embodiment of the present invention, there are at least three beams 20 equally spaced apart supporting the vertical axis fluid flow turbines 10.

The base 22 of all of the above embodiments might be a roof top, the ground, or the floor of a body of water.

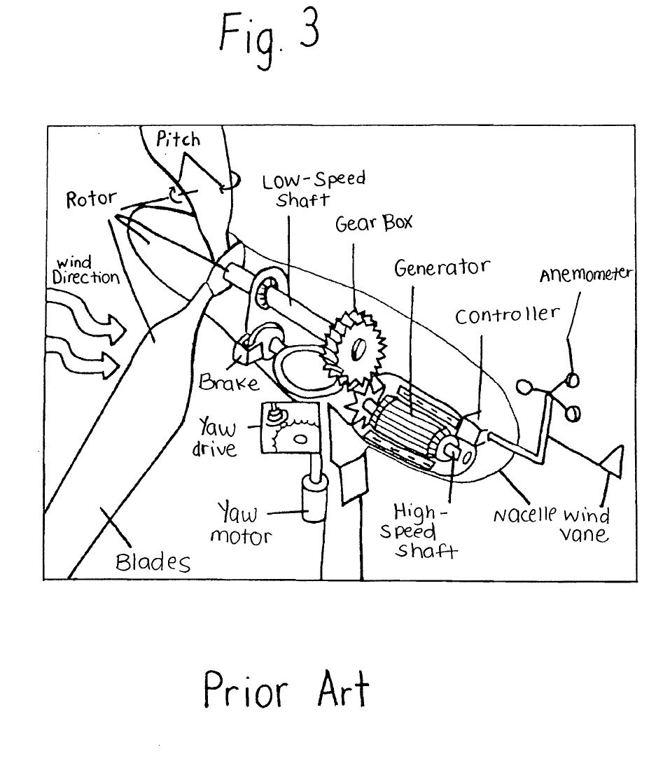

FIG. 3 shows the normal elements housed within the nacelle of a wind turbine, the Prior Art. The present invention uses substantially similar elements as the prior art. The positioning of the rotor in relationship to the blades of the present invention is one of the novel aspects of the present invention. The positioning allows the embodiments of the present invention to be stacked in the manner described above.

An advantage of the present invention is that it captures the maximum amount of fluid flow within a certain area of a roof top, the ground, or the floor of a body of water to create energy.

A further advantage of the present invention is that it securely places a fluid flow turbine system on top of a building.

Yet another advantage of the present invention is that it places a fluid flow turbine system within a metropolitan area.

Still another advantage of the present invention is that it promotes developers of metropolitan buildings to place alternative energy sources on metropolitan building rooftops.

Another advantage of the present invention is that it places a fluid flow turbine system under a body of water.

Although the present invention has been described in considerable detail with reference to certain preferred versions thereof, other versions are possible. Therefore the spirit and the scope of the claims should not be limited to the description of the preferred versions contained herein.

What is claimed is:

1. A vertical axis fluid flow turbine system comprising:
At least one vertical axis fluid flow turbine, the fluid flow turbine having a rotor, a break, a low speed shaft, a gear box, a high speed shaft, a generator, a controller, and a nacelle, the rotor comprises of a hub and at least two blades, the blades are propeller styled blades that extend outward from the hub so that the axis of the blades are perpendicular to the low speed shaft, the nacelle houses all the elements of the fluid flow turbine except the rotor and the blades;
at least two beams, each beam being of a diameter and structural strength to support the weight of at least one vertical axis fluid flow turbine or any combination of vertical axis fluid flow turbines made to be supported between the beams;
a base, the beams being securely attached to the base so that the beams are perpendicular to the base, the beams being spaced apart so that the axis of each blade of each vertical axis fluid flow turbine will have enough clearance to spin within the beams;
at least one set of struts, each set of struts has at least two rods, each rod being of an equal length and diameter and having the structural strength to hold the weight of one vertical axis fluid flow turbine, each rod is securely attached to each beam and the nacelle of each vertical axis fluid flow turbine supported between the beams; and
a conductor connected to the generator.

2. The vertical axis fluid flow turbine system of claim 1, wherein the blades are shaped so that one side of each blade is nearly flat or somewhat concave from the chord and the other side of each blade is convex.

3. The vertical axis fluid flow turbine system of claim 2, wherein there are two vertical axis fluid flow turbines supported by the beams, the fluid flow turbines being spaced apart so that the nacelle of one of the fluid flow turbines does not touch the rotor of the second fluid flow turbine and wherein the nacelles of the fluid flow turbines are colinear.

4. The vertical axis fluid flow turbine system of claim 3, wherein there is at least a third vertical axis fluid flow turbine that is connected to the beams and being spaced apart so that the nacelle of the third fluid flow turbine and any subsequent turbine does not touch the rotor of any other fluid flow turbine being supported by the beams, and wherein the nacelles of all of the fluid flow turbines are colinear.

5. The vertical axis fluid flow turbine of claim 4, wherein the controller controls the blades to rotate to a desired pitch thereby allowing the fluid flow turbine's blades to be adjusted to provide the optimum resistance to fluid flows.

6. The vertical axis fluid flow turbine of claim 5, wherein there are at least three beams equally spaced apart.

7. The vertical axis fluid flow turbine system of claim 6, wherein the base is a roof top.

8. The vertical axis fluid flow turbine system of claim 6, wherein the base is the ground.

9. The vertical axis fluid flow turbine system of claim 6, wherein the base is the floor of a body of water.

10. The vertical axis fluid flow turbine of claim 3, wherein the controller controls the blades to rotate to a desired pitch thereby allowing the fluid flow turbine's blades to be adjusted to provide the optimum resistance to fluid flows.

11. The vertical axis fluid flow turbine of claim 10, wherein there are at least three beams equally spaced apart.

12. The vertical axis fluid flow turbine system of claim 11, wherein the base is a roof top.

13. The vertical axis fluid flow turbine system of claim 11, wherein the base is the ground.

14. The vertical axis fluid flow turbine system of claim 11, wherein the base is the floor of a body of water.

15. The vertical axis fluid flow turbine of claim 2, wherein the controller controls the blades to rotate to a desired pitch thereby allowing the fluid flow turbine's blades to be adjusted to provide the optimum resistance to fluid flows.

16. The vertical axis fluid flow turbine system of claim 15, wherein the base is a roof top.

17. The vertical axis fluid flow turbine system of claim 15, wherein the base is the ground.

18. The vertical axis fluid flow turbine system of claim 15, wherein the base is the floor of a body of water.
